(19) United States
(12) Patent Application Publication
(10) Pub. No.: US 2025/0210918 A1
(43) Pub. Date: Jun. 26, 2025

(54) CONNECTOR, TERMINAL ARRANGEMENT METHOD, AND ELECTRONIC DEVICE

(71) Applicant: HUAWEI TECHNOLOGIES CO., LTD., Shenzhen (CN)

(72) Inventors: Zewen Wang, Shenzhen (CN); Congtu Xiao, Dongguan (CN); Wang Xiong, Dongguan (CN); Jun Chen, Dongguan (CN); Kunpeng Wang, Dongguan (CN)

(73) Assignee: HUAWEI TECHNOLOGIES CO., LTD., Shenzhen (CN)

(21) Appl. No.: 19/074,220

(22) Filed: Mar. 7, 2025

Related U.S. Application Data
(63) Continuation of application No. PCT/CN2023/100432, filed on Jun. 15, 2023.

(30) Foreign Application Priority Data
Sep. 9, 2022 (CN) 202211099695.4

(51) Int. Cl. H01R 13/6471; H01R 13/405

(52) U.S. Cl. CPC H01R 13/6471; H01R 13/405

(57) ABSTRACT

A connector includes: a housing including at least one longitudinal separation rib, where the at least one longitudinal separation rib separates the housing into a plurality of module cavities; and a plurality of modules, where each module in the plurality of modules is disposed in one module cavity in the plurality of module cavities that corresponds to the module. The plurality of modules are combined and then divided into at least one low-speed area and at least one high-speed area, and the at least one low-speed area and the at least one high-speed area are arranged in a specified sequence. Any one of the plurality of modules includes a plurality of terminals. An increasing demand for high-speed signal transmission can be met, and a thermal deformation resistance capability is strong. A good anti-crosstalk capability is provided, and a shielding sheet does not need to be disposed between all signal terminals.

### CROSS-REFERENCE TO RELATED APPLICATIONS

This application is a continuation of International Application No. PCT/CN2023/100432, filed on Jun. 15, 2023, which claims priority to Chinese Patent Application No. 202211099695.4, filed on Sep. 9, 2022. The disclosures of the aforementioned applications are hereby incorporated by reference in their entireties.

### TECHNICAL FIELD

This application relates to the field of electronic component technologies, and in particular, to a connector, a terminal arrangement method, and an electronic device.

### BACKGROUND

With continuous and rapid development of the high-speed communication field, various components and modules on boards are constantly increasing for carrying and transmitting more new services. Although the components and modules develop toward miniaturization and integration, layout space of the boards is limited. In order to effectively transmit more service information in time, a single-port transmission rate of an input/output (I/O) connector is also being continuously updated and upgraded, evolving from an early hundred-megabit network port connector to a current optical port I/O connector with 400G or above. With the improvement of the I/O port transmission rate, the board can carry larger information capacity, and a quantity of used components and modules can be reduced while a same information transmission requirement is met, thereby providing layout space for new functions of the board.

One way to improve the single-port rate of the I/O connector is to increase a quantity of terminals. However, a size of the I/O connector increases with the quantity of terminals. As a result, a thermal deformation resistance capability of the I/O connector deteriorates. This results in a risk of coefficient of thermal expansion (CTE) mismatch during matching of the I/O connector with various parts such as a printed circuit board (PCB), potentially causing a fault such as link breakage.

In addition, to avoid crosstalk between the terminals, a shielding sheet is usually disposed between the terminals to avoid crosstalk between differential pairs. However, in a compactly structured connector, it is difficult to dispose a shielding sheet between all adjacent terminals, and manufacturing costs are high.

### SUMMARY

In embodiments of this application, a connector, a terminal arrangement method, and an electronic device are provided, so that an increasing demand for high-speed signal transmission can be met, and a thermal deformation resistance capability is strong. In addition, a good anti-crosstalk capability is provided, and a shielding sheet does not need to be disposed between all signal terminals, so that manufacturing difficulty and costs are low.

According to a first aspect, a connector is provided, including: a housing and a plurality of modules. The housing includes at least one longitudinal separation rib, and the at least one longitudinal separation rib is disposed in the housing along a direction perpendicular to a length direction of the housing. The at least one longitudinal separation rib separates the housing into a plurality of module cavities. The plurality of modules are in one-to-one correspondence with the plurality of module cavities, and each module in the plurality of modules is disposed in one module cavity in the plurality of module cavities that corresponds to the module. The plurality of modules are combined and then divided into at least one low-speed area and at least one high-speed area, and the at least one low-speed area and the at least one high-speed area are arranged in a specified sequence. Any one of the plurality of modules includes a plurality of terminals. The longitudinal separation rib can enhance strength of the housing and suppress deformation of the housing. A quantity of modules may be expanded as required by disposing the longitudinal separation rib, to provide more I/O transmission ports, thereby greatly improving a data transmission capability of the connector. In addition, I/O transmission ports are respectively disposed on the plurality of modules, so that a deformation amount can be distributed to the plurality of modules, to mitigate deformation of the whole modules.

In a possible implementation, a rear cover is further included. The rear cover is disposed at end parts that are located on a same side of the plurality of module cavities, and is fastened to the housing. One edge of the rear cover is closely attached to end parts of the plurality of terminals. The rear cover is fastened to the housing and closely attached to the end part of the terminal, and fits with the terminal without a gap, to suppress deformation and warping of the terminal, thereby achieving a function of deformation resistance. In addition, after the rear cover is fastened to the housing, the rear cover has strengthening effect on a housing structure, and can also prevent the housing from deforming due to heat.

In a possible implementation, the housing further includes a strengthening part. The strengthening part is disposed at an edge of the housing, and fastened to the rear cover without a gap. The strengthening part includes a plurality of cross beams and a plurality of longitudinal beams. The plurality of cross beams are vertically connected to the plurality of longitudinal beams in pairs. The use of the strengthening part with the plurality of cross beams intersecting with the plurality of longitudinal beams, and the use of a manner of fastening the strengthening part to the rear cover without a gap can further improve a deformation resistance capability of the whole housing.

In a possible implementation, any one of the plurality of modules includes a plurality of plastic assemblies, and each plastic assembly includes a plurality of terminals and a plastic member that is injection-molded outside the terminal. Two ends of the plurality of terminals are exposed outside the plastic member. A plurality of mutually parallel first stiffened plates are disposed on one of the plurality of plastic assemblies. The plurality of first stiffened plates disposed on the plastic assembly can enhance structural strength of the plastic assembly, so that a thermal deformation resistance capability of the plastic assembly is enhanced.

In a possible implementation, any one of the plurality of modules further includes a second stiffened plate, fixedly disposed on the plastic assembly provided with the plurality of first stiffened plates. The second stiffened plate is vertically connected to the plurality of first stiffened plates, and the second stiffened plate is closely attached to end parts of the plurality of terminals. The second stiffened plate is rigidly connected to the first stiffened plate, and acts on the end parts of the plurality of terminals, to effectively suppress deformation caused due to warping of the end parts of the terminals. In addition, a fixed connection relationship is established between the plurality of first stiffened plates, the second stiffened plate, and the plastic assembly, so that a deformation resistance capability of the plastic assembly can be further improved, thereby improving a deformation resistance capability of the module.

In a possible implementation, the rear cover includes at least one protrusion part, closely attached to an end part of the second stiffened plate. The at least one protrusion part is arranged along a same straight line, and one end face of the at least one protrusion part is located on a same plane. The rear cover uses the protrusion part to press the end part of the second stiffened plate, and forms a rigid connection with the second stiffened plate, so that pressure of the second stiffened plate on the end parts of the plurality of terminals is more stable, to effectively suppress deformation and warping of the end parts of the plurality of terminals.

In a possible implementation, sliding grooves are provided on inner walls of the plurality of module cavities. Sliding rails corresponding to the sliding grooves are disposed on outer surfaces of the plurality of modules, and the sliding rails are slidably connected to the sliding grooves. The module is fastened to the module cavity through the sliding rail, to improve stability of the module, and the module may be replaced.

In a possible implementation, the sliding groove includes a plurality of first sliding grooves and a plurality of second sliding grooves. The plurality of first sliding grooves and the plurality of second sliding grooves are respectively provided on inner walls of the module cavity that are symmetrical to each other. The sliding rail includes a plurality of first sliding rails and a plurality of second sliding rails. The plurality of first sliding rails and the plurality of second sliding rails are respectively disposed on outer surfaces of the module that are symmetrical to each other. The plurality of first sliding rails are slidably connected to the plurality of first sliding grooves in one-to-one correspondence, and the second sliding rails are slidably connected to the second sliding grooves in one-to-one correspondence.

In a possible implementation, the at least one longitudinal separation rib separates the housing into a plurality of module cavities of a same size. The plurality of modules have a same size, and any two of the plurality of modules have a same quantity and a same terminal arrangement sequence of terminals. The modules with a completely same structure facilitate modularization of a product, do not require repeated moldmaking, and production efficiency is high.

In a possible implementation, the rear cover is riveted to the housing. The rear cover may be fastened to the housing through hot riveting, which is simple in process and low in cost.

According to another aspect, a terminal arrangement method is provided, applied to the connector. The connector includes a plurality of low-speed signal terminals and a plurality of high-speed signal terminals, and further includes a low-speed signal terminal area and a high-speed signal terminal area. The low-speed signal terminal area is used for arrangement of the plurality of low-speed signal terminals, and the high-speed signal terminal area is used for arrangement of the plurality of high-speed signal terminals. The low-speed signal terminal area and the high-speed signal terminal area are respectively disposed at two end parts of the connector, and the low-speed signal terminal area is adjacent to the high-speed signal terminal area. The low-speed area and the high-speed area are separately provided in a centralized manner, to reduce crosstalk between the high-speed and low-speed terminals, and a shielding sheet does not need to be disposed between all signal terminals, so that manufacturing difficulty and costs are low.

According to still another aspect, a terminal arrangement method is provided, applied to the connector. The connector includes a plurality of low-speed signal terminals and a plurality of high-speed signal terminals, and further includes one low-speed signal terminal area and two high-speed signal terminal areas. The low-speed signal terminal area is used for arrangement of the plurality of low-speed signal terminals, and the two high-speed signal terminal areas are used for arrangement of the plurality of high-speed signal terminals. The low-speed signal terminal area is provided between the two high-speed signal terminal areas, and is adjacent to the two high-speed signal terminal areas. The two high-speed signal terminal areas are respectively provided at two end parts of the connector. The low-speed area and the high-speed areas are separately provided in a centralized manner, and the high-speed areas are respectively provided on two sides of the low-speed area, to reduce crosstalk between the high-speed and low-speed terminals, and a shielding sheet does not need to be disposed between all signal terminals, so that manufacturing difficulty and costs are low.

According to yet another aspect, an electronic device is provided, including a circuit board, a chip, and the connector. The chip and the connector are arranged on the circuit board, and the connector is used as a communication interface of the circuit board for information transmission between chips. The electronic device with the connector provided in this application can support information transmission rates ranging from 400G, 800G to 1.6 T, greatly improving a transmission rate of the communication interface to meet an increasing demand for information transmission.

### BRIEF DESCRIPTION OF DRAWINGS

FIG. 1 is an exploded view of a structure of a connector according to an embodiment of this application;

FIG. 2 is a diagram of an external structure of a connector according to an embodiment of this application;

FIG. 3 is a diagram of a structure of a side wall of a module cavity according to an embodiment of this application;

FIG. 4 is a diagram of a structure of a plastic assembly according to an embodiment of this application;

FIG. 5 is a side view and a partial cross-section of a connector according to an embodiment of this application;

FIG. 6 is a diagram of terminal arrangement according to an embodiment of this application; and

FIG. 7 is a diagram of another terminal arrangement according to an embodiment of this application.

### DESCRIPTION OF EMBODIMENTS

In a conventional application scenario, a quantity of terminals is increased to improve a single-port rate of an I/O connector. Therefore, a length of the I/O connector may be significantly increased with the quantity of terminals, directly leading to a problem of an increasingly poor thermal deformation resistance capability of the I/O connector. Deformation of the I/O connector results in a higher risk of CTE mismatch during matching of the I/O connector with various parts such as a PCB board, thereby potentially causing a fault such as link breakage.

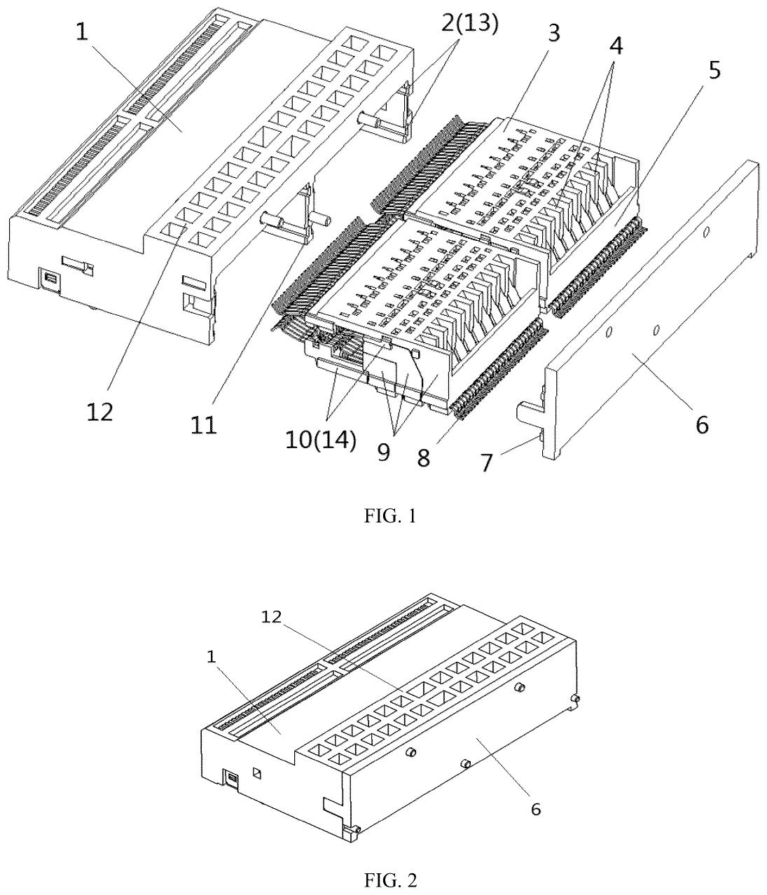

Therefore, an embodiment of this application provides a connector. FIG. 1 is an exploded view of a structure of a connector according to an embodiment of this application. As shown in FIG. 1, the connector includes a housing 1 and a plurality of modules 3. The housing 1 includes at least one longitudinal separation rib 11, and the at least one longitudinal separation rib 11 is disposed in the housing 1 along a direction perpendicular to a length direction of the housing 1. The at least one longitudinal separation rib 11 separates the housing 1 into a plurality of module cavities. The plurality of modules 3 are in one-to-one correspondence with the plurality of module cavities, and each module 3 of the plurality of modules 3 is disposed in one module cavity in the plurality of module cavities that corresponds to the module 3. The plurality of modules 3 are combined and then divided into at least one low-speed area and at least one high-speed area. The at least one low-speed area and the at least one high-speed area are arranged in a specified sequence. Any one of the plurality of modules 3 includes a plurality of terminals 8. The low-speed area and the high-speed area are arranged together adjacent to each other, and both the low-speed area and the high-speed area may include different quantities of terminals 8. Terminals 8 in the low-speed area are continuously distributed in the low-speed area, and terminals 8 in the high-speed area are also continuously distributed in the high-speed area. In an example, the low-speed area may be provided adjacent to the high-speed area, or the low-speed area may be provided between high-speed areas.

In a possible embodiment, the connector further includes a rear cover 6. The rear cover 6 is disposed at end parts that are located on a same side of the plurality of module cavities, and is fastened to the housing 1. One edge of the rear cover 6 is closely attached to end parts of the plurality of terminals 8. The housing 1, the longitudinal separation rib 11, and the rear cover 6 may all be made of insulation materials. The housing 1 and the longitudinal separation rib 11 may be integrally molded, or may be detachably connected to each other, and the longitudinal separation rib 11 has specific strength. The module 3 includes a plurality of plastic assemblies 9 (which is also referred to as wafers), and each plastic assembly 9 includes a plurality of terminals 8 and a plastic member that is injection-molded outside the terminal 8. Two ends of the plurality of terminals are exposed outside the plastic member. A plurality of mutually parallel first stiffened plates 4 are disposed on one of the plurality of plastic assemblies 9. The plurality of first stiffened plates 4 disposed on the plastic assembly 9 can enhance structural strength of the plastic assembly 9, so that a thermal deformation resistance capability of the plastic assembly 9 is enhanced. The plurality of terminals 8 are arranged together in order in the plastic assembly 9. A quantity of terminals 8 in the module 3 may be set as required. In addition, the plurality of modules 3 disposed in the same connector may be the same, or may be different, and the module cavities need to be in one-to-one correspondence with the modules 3. The rear cover 6 may be fastened to the housing 1 through hot riveting, or may be fastened to the housing 1 in another manner, for example, in plug-in connection or snap-fit connection. The edge of the rear cover 6 may be closely attached to the end parts of the plurality of terminals 8, providing securing effect on the end parts of the terminals 8 after assembly, to prevent the terminals 8 from deforming due to heat-induced warping. In addition, the rear cover 6 also has reinforcing effect on the housing 1, to prevent the housing from deforming due to heat.

In an example, a plurality of cylinders are further disposed at an edge of the housing 1 of the connector, and a plurality of through holes corresponding to the plurality of cylinders are also provided on the rear cover 6. When the housing 1 is assembled with the rear cover 6, the plurality of cylinders are respectively inserted into the plurality of through holes. Finally, the plurality of cylinders are fastened to the plurality of through holes through hot melting and hot riveting.

In addition to separating the housing 1 into the plurality of module cavities, the longitudinal separation rib 11 can further enhance strength of the housing 1 and suppress deformation of the housing 1. A quantity of modules 3 may be expanded as required by disposing the longitudinal separation rib 11, to provide more I/O transmission ports, thereby greatly improving a data transmission capability of the connector. In addition, I/O transmission ports are respectively disposed on the plurality of modules 3, so that deformation amount can be distributed to the plurality of modules 3, to mitigate deformation of the whole modules 3. The rear cover 6 is fastened to the housing 1 and closely attached to the end part of the terminal 8, and fits with the terminal 8 without a gap, to suppress deformation and warping of the terminal 8, thereby achieving a function of deformation resistance.

The plurality of plastic assemblies 9 may be detachably connected together through a snap-fit or may be fastened through injection molding. The plurality of first stiffened plates 4 are disposed on one of the plurality of plastic assemblies 9. The plurality of first stiffened plates 4 are used to enhance structural strength of the plastic assembly 9, so as to enhance a thermal deformation resistance capability of the plastic assembly 9. The first stiffened plate 4 is fixedly disposed on the plastic assembly 9, and may be integrally molded with the plastic assembly 9. For example, the first stiffened plate 4 may be disposed at a position close to end parts of the plurality of terminals 8, a thickness of the first stiffened plate 4 may be set as required, and a shape of the first stiffened plate 4 may also be set based on a structure of the plastic assembly 9, to enhance structural strength of the plastic assembly 9.

In a possible embodiment, any one of the plurality of modules 3 further includes a second stiffened plate 5. The second stiffened plate 5 is fixedly disposed on the plastic assembly 9 provided with the first stiffened plate 4, and is perpendicular and fastened to the plurality of first stiffened plates 4. The second stiffened plate 5 is closely attached to the end parts of the plurality of terminals 8. The second stiffened plate 5 is rigidly connected to the plurality of first stiffened plates 4, and acts on the end parts of the plurality of terminals 8, to effectively suppress deformation caused due to warping of the end parts of the terminals 8. In addition, a fixed connection relationship is established between the plurality of first stiffened plates 4, the second stiffened plate 5, and the plastic assembly 9, so that a deformation resistance capability of the plastic assembly 9 can be further improved, thereby improving a deformation resistance capability of the whole module. It should be noted that, the second stiffened plate 5 may be an entire plate, or may be a plurality of combined stiffened plates sequentially fastened to each other. In a manner of combining a plurality of stiffened plates, the plurality of stiffened plates are sequentially fastened to each other along a same straight line. The plurality of stiffened plates are perpendicular and fastened to the plurality of first stiffened plates 4, and a plurality of end parts of the plurality of combined stiffened plates are fastened to the plastic assembly 9.

In a possible embodiment, the at least one longitudinal separation rib 11 separates the housing 1 into a plurality of module cavities of a same size. The plurality of modules 3 have a same size, and any two of the plurality of modules 3 have a same quantity and a same terminal arrangement sequence of terminals 8. The modules 3 with a completely same structure facilitate modularization of a product, do not require repeated moldmaking, and production efficiency is high. For example, terminals 8 in the module 3 are horizontally arranged and use a 4×30 pin structure. A high-performance coherent module (HCM) connector includes two same modules 3. This can achieve 240-pin 32-lane high-speed transmission, support a transmission rate of 400G or above, and support generational evolution of high-performance coherent optical modules in transport networks from 400G, 800G to 1.6 T. A length of the HCM connector can be greater than 41.4 mm.

FIG. 2 is a diagram of an external structure of a connector according to an embodiment of this application. With reference to FIG. 2, the housing 1 may be further provided with a strengthening part 12. The strengthening part 12 is disposed at an edge of the housing 1, and is fastened to the rear cover 6 without a gap. The strengthening part 12 includes a plurality of cross beams and a plurality of longitudinal beams. The plurality of cross beams and the plurality of longitudinal beams are vertically connected to each other to form a rectangular grid structure. The use of the strengthening part 12 with the plurality of cross beams intersecting with the plurality of longitudinal beams, and the use of a manner of fastening the strengthening part 12 to the rear cover 6 without a gap can further improve a deformation resistance capability of the whole housing 1. For example, the strengthening part 12 and the housing 1 may be integrally molded. The strengthening part 12 is disposed at the edge of the housing 1, that is, the end part of the terminal 8, and has a specific thickness. A grid shape of the strengthening part 12 may be a square, a rectangle, or a combination thereof.

In a possible embodiment, the rear cover 6 and the housing 1 may be fastened to the housing 1 through hot riveting. The rear cover 6 is fastened to the housing 1 through hot riveting, which is simple in process and low in cost.

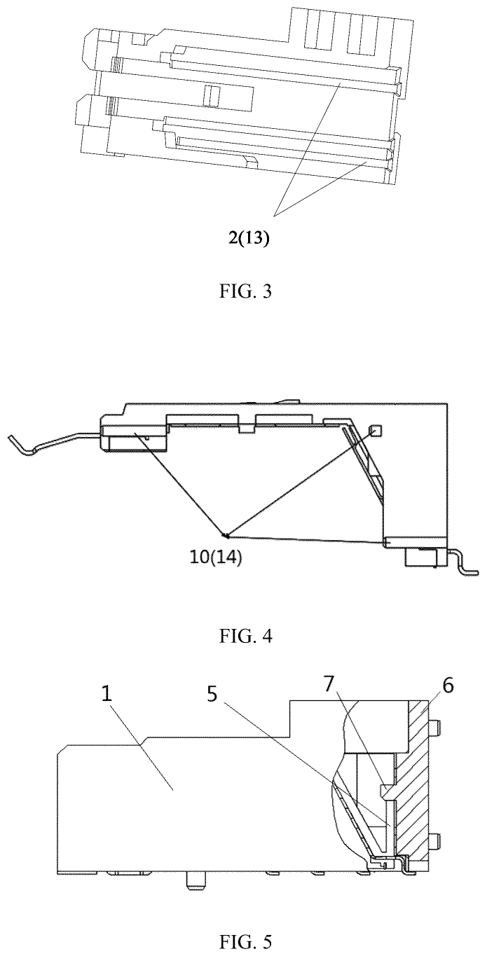

FIG. 3 is a diagram of a structure of a side wall of a module cavity according to an embodiment of this application. FIG. 4 is a diagram of a structure of a plastic assembly according to an embodiment of this application. With reference to FIG. 3 and FIG. 4, sliding grooves are provided on inner walls of the plurality of module cavities. Sliding rails corresponding to the sliding grooves are disposed on outer surfaces of the plurality of modules 3, and the sliding rails are slidably connected to the sliding grooves. The module 3 is fastened to the module cavity through the sliding rail, to improve stability of the module 3, and the module 3 may be replaced. For example, the sliding groove may further include a plurality of first sliding grooves 2 and a plurality of second sliding grooves 13. The plurality of first sliding grooves 2 and the plurality of second sliding grooves 13 are respectively provided on inner walls of the module cavity that are symmetrical to each other. To be specific, the plurality of first sliding grooves 2 are provided on one inner wall of the module cavity, and the plurality of second sliding grooves 13 are provided on another inner wall of the module cavity that is symmetrical to the inner wall of the module cavity. In an example, the plurality of first sliding grooves 2 and the plurality of second sliding grooves 13 may be provided symmetrically or asymmetrically. The sliding rail may include a plurality of first sliding rails 10 and a plurality of second sliding rails 14. The plurality of first sliding rails 10 and the plurality of second sliding rails 14 are respectively disposed on outer surfaces of the module 3 that are symmetrical to each other. To be specific, the plurality of first sliding rails 10 are disposed on an outer surface of one module 3, and the plurality of second sliding rails 14 are disposed on another outer surface of the module that is symmetrical to the outer surface of the module. In an example, the plurality of first sliding rails 10 and the plurality of second sliding rails 14 may be disposed symmetrically or asymmetrically, provided that the plurality of first sliding rails 10 are slidably connected to the plurality of first sliding grooves 2 in one-to-one correspondence, and the plurality of second sliding rails 14 are slidably connected to the second sliding grooves 13 in one-to-one correspondence. In another example, the plurality of first sliding rails 10 or the plurality of second sliding rails 14 may alternatively be a plurality of staggered sliding rails that are not connected to each other. The staggered sliding rails may be symmetrically disposed correspondingly, or may be asymmetrically disposed. Correspondingly, the plurality of first sliding grooves 2 or the plurality of second sliding grooves 13 may alternatively be a plurality of staggered sliding grooves that are not connected to each other. The staggered sliding grooves may be symmetrically provided correspondingly, or may be asymmetrically provided. The plurality of staggered sliding grooves need to be matched with the plurality of staggered sliding rails.

FIG. 5 is a side view and a partial cross-section of a connector according to an embodiment of this application. With reference to FIG. 1 and FIG. 5, the rear cover 6 includes at least one protrusion part 7, and the at least one protrusion part 7 is closely attached to an end part of the second stiffened plate 5. The at least one protrusion part 7 may be arranged along a same straight line, and one end face of the at least one protrusion part 7 is located on a same plane, so that the at least one protrusion part 7 is closely attached to the end part of the second stiffened plate 5. The rear cover 6 uses the protrusion part 7 to press the end part of the second stiffened plate 5, and forms a rigid connection with the second stiffened plate 5, so that pressure of the second stiffened plate 5 on the end parts of the plurality of terminals 8 is more stable, to effectively suppress deformation and warping of the end parts of the plurality of terminals 8. For example, the protrusion part 7 may be strip-shaped. There is a distance between a plurality of protrusion parts 7, and the plurality of protrusion parts 7 are used to cooperate with the longitudinal separation rib 11. In other words, the longitudinal separation rib 11 is located between the plurality of protrusion parts 7 and is fittingly fastened to the plurality of protrusion parts 7. Lower edges of the plurality of protrusion parts 7 are directly attached to an upper edge of the second stiffened plate 5, and a lower edge of the rear cover 6 is also attached to the end parts of the plurality of terminals 8.

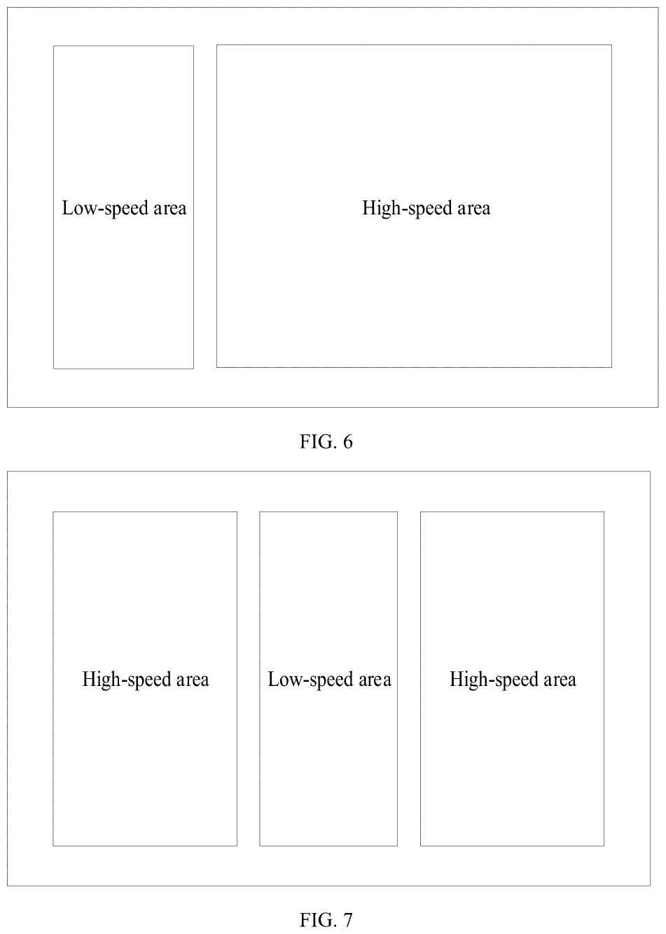

FIG. 6 is a diagram of terminal arrangement according to an embodiment of this application. As shown in FIG. 6, the terminal arrangement method is provided, applied to the connector. The connector includes a plurality of low-speed signal terminals and a plurality of high-speed signal terminals, and further includes a low-speed signal terminal area and a high-speed signal terminal area. The low-speed signal terminal area is used for arrangement of the plurality of low-speed signal terminals, and the high-speed signal terminal area is used for arrangement of the plurality of high-speed signal terminals. The low-speed signal terminal area and the high-speed signal terminal area are respectively disposed at two end parts of the connector, and the low-speed signal terminal area is adjacent to the high-speed signal terminal area.

Crosstalk means an impact of electromagnetic coupling on adjacent transmission lines when signals are transmitted on transmission channels. Excessive crosstalk may cause the circuit to be triggered by mistake. As a result, a system cannot work normally. The crosstalk usually occurs in a process of signal jump. A faster changing signal indicates a greater crosstalk generated. When a changing signal is restored to a steady direct current level, a coupled signal gradually decreases until the coupled signal disappears. In this embodiment of this application, the low-speed area and the high-speed area are separately provided, and coupling inductances generated between the low-speed area and the high-speed area cancel each other. This arrangement method of high-speed and low-speed signal terminals can effectively reduce crosstalk between the high-speed and low-speed terminals. Therefore, in this embodiment of this application, a shielding sheet does not need to be disposed between all signal terminals, and manufacturing difficulty and costs are low.

FIG. 7 is a diagram of another terminal arrangement according to an embodiment of this application. As shown in FIG. 7, the terminal arrangement method is provided, applied to the connector. The connector includes a plurality of low-speed signal terminals and a plurality of high-speed signal terminals, and further includes one low-speed signal terminal area and two high-speed signal terminal areas. The low-speed signal terminal area is used for arrangement of the plurality of low-speed signal terminals, and the two high-speed signal terminal areas are used for arrangement of the plurality of high-speed signal terminals. The low-speed signal terminal area is provided between the two high-speed signal terminal areas, and is adjacent to the two high-speed signal terminal areas. The two high-speed signal terminal areas are respectively provided at two end parts of the connector. Similar to the principle of the foregoing embodiment, the high-speed areas are respectively provided on two sides of the low-speed area, and coupling inductances separately generated between the low-speed area and the high-speed area cancel each other. This arrangement method of high-speed and low-speed signal terminals can also reduce crosstalk between the high-speed and low-speed terminals. Therefore, in this embodiment of this application, a shielding sheet does not need to be disposed between all signal terminals, and manufacturing difficulty and costs are low.

An embodiment of this application further provides an electronic device, including a circuit board, a chip, and the connector. The chip and the connector are arranged on the circuit board, and the connector is electrically connected to the chip. The connector may be used as a communication interface of the circuit board for information transmission between chips.

In embodiments of this application, the electronic device with the connector provided in this application can support information transmission rates ranging from 400G, 800G to 1.6 T, greatly improving a transmission rate of the communication interface, so that the electronic device can handle a faster information transmission task.

The foregoing descriptions are merely example specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A connector comprising:
a housing comprising at least one longitudinal separation rib disposed in the housing along a direction perpendicular to a length direction of the housing, wherein the at least one longitudinal separation rib separates the housing into a plurality of module cavities; and
a plurality of modules in one-to-one correspondence with the plurality of module cavities, wherein each module in the plurality of modules is disposed in a module cavity in the plurality of module cavities corresponding to the module, wherein the plurality of modules are combined and then divided into at least one low-speed area and at least one high-speed area, wherein the at least one low-speed area and the at least one high-speed area are arranged in a sequence, and wherein any one of the plurality of modules comprises a plurality of terminals.

2. The connector according to claim 1, further comprising:
a rear cover disposed at end parts located on a same side of the plurality of module cavities and fastened to the housing, wherein one edge of the rear cover is attached to end parts of the plurality of terminals.

3. The connector according to claim 2, wherein the housing further comprises:
a strengthening part disposed at an edge of the housing and fastened to the rear cover without a gap, wherein the strengthening part comprises a plurality of cross beams and a plurality of longitudinal beams and the plurality of cross beams are vertically connected to the plurality of longitudinal beams in pairs.

4. The connector according to claim 2, wherein any one of the plurality of modules comprises a plurality of plastic assemblies, and each plastic assembly comprises a plurality of terminals and a plastic member that is injection-molded outside the terminal, wherein
two ends of the plurality of terminals are exposed outside the plastic member; and
a plurality of mutually parallel first stiffened plates are disposed on one of the plurality of plastic assemblies.

5. The connector according to claim 4, wherein any one of the plurality of modules further comprises:
a second stiffened plate fixedly disposed on the plastic assembly provided with the plurality of first stiffened plates, wherein the second stiffened plate is vertically connected to the plurality of first stiffened plates, wherein the second stiffened plate is attached to end parts of the plurality of terminals.

6. The connector according to claim 5, wherein the rear cover comprises:
at least one protrusion part attached to an end part of the second stiffened plate, wherein the at least one protrusion part is arranged along a same straight line, and wherein one end face of the at least one protrusion part is located on a same plane.

7. The connector according to claim 1, wherein
sliding grooves are provided on inner walls of the plurality of module cavities; and
sliding rails corresponding to the sliding grooves are disposed on outer surfaces of the plurality of modules, and wherein the sliding rails are slidably connected to the sliding grooves.

8. The connector according to claim 7, wherein
the sliding groove comprises a plurality of first sliding grooves and a plurality of second sliding grooves, wherein the plurality of first sliding grooves and the plurality of second sliding grooves are respectively provided on inner walls of the module cavity that are symmetrical to each other;
the sliding rail comprises a plurality of first sliding rails and a plurality of second sliding rails, wherein the plurality of first sliding rails and the plurality of second sliding rails are respectively disposed on outer surfaces of the module that are symmetrical to each other; and
the plurality of first sliding rails are slidably connected to the plurality of first sliding grooves in one-to-one correspondence, and the plurality of second sliding rails are slidably connected to the plurality of second sliding grooves in one-to-one correspondence.

9. The connector according to claim 1, wherein
the at least one longitudinal separation rib separates the housing into the plurality of module cavities having a same size;
each of the plurality of modules has a same structure and size; and
low-speed areas and high-speed areas of any two of the plurality of modules are arranged in a same method.

10. A terminal arrangement method, applied to a connector, comprising:
a housing comprising at least one longitudinal separation rib disposed in the housing along a direction perpendicular to a length direction of the housing, wherein the at least one longitudinal separation rib separates the housing into a plurality of module cavities; and
a plurality of modules in one-to-one correspondence with the plurality of module cavities, wherein each module in the plurality of modules is disposed in a module cavity in the plurality of module cavities corresponding to the module, wherein the plurality of modules are combined and then divided into at least one low-speed area and at least one high-speed area, wherein the at least one low-speed area and the at least one high-speed area are arranged in a sequence, and wherein any one of the plurality of modules comprises a plurality of terminals;
wherein the connector comprises a plurality of low-speed signal terminals and a plurality of high-speed signal terminals, and comprises:
a low-speed signal terminal area for arranging the plurality of low-speed signal terminals; and
a high-speed signal terminal area for arranging the plurality of high-speed signal terminals,
wherein the low-speed signal terminal area and the high-speed signal terminal area are respectively disposed at two end parts of the connector, and
wherein the low-speed signal terminal area is adjacent to the high-speed signal terminal area.

11. An electronic device comprising a circuit board, a chip and a connector, comprising:
a housing comprising at least one longitudinal separation rib disposed in the housing along a direction perpendicular to a length direction of the housing, wherein the at least one longitudinal separation rib separates the housing into a plurality of module cavities; and
a plurality of modules in one-to-one correspondence with the plurality of module cavities, wherein each module in the plurality of modules is disposed in a module cavity in the plurality of module cavities corresponding to the module, wherein the plurality of modules are combined and then divided into at least one low-speed area and at least one high-speed area, wherein the at least one low-speed area and the at least one high-speed area are arranged in a sequence, and wherein any one of the plurality of modules comprises a plurality of terminals;
wherein the chip and the connector are arranged on the circuit board, and the connector is electrically connected to the chip.
